(19) United States
(12) Patent Application Publication
(10) Pub. No.: US 2013/0253943 A1
(43) Pub. Date: Sep. 26, 2013

(54) EXERCISE MANAGEMENT APPARATUS, SYSTEM AND METHOD

(71) Applicant: SAMSUNG ELECTRONICS CO., LTD., Gyeonggi-do (KR)

(72) Inventors: Jong-Hyo LEE, Gyeonggi-do (KR); Jun-Hyung Kim, Gyeonggi-do (KR)

(73) Assignee: Samsung Electronics Co., Ltd., Gyeonggi-do (KR)

(21) Appl. No.: 13/837,666

(22) Filed: Mar. 15, 2013

(30) Foreign Application Priority Data
Mar. 21, 2012 (KR) 10-2012-0028581

(51) Int. Cl. G06Q 50/22; G06Q 10/10

(52) U.S. Cl. CPC G06Q 50/22; G06Q 10/10
USPC 705/2

(57) ABSTRACT

An exercise management method, apparatus, and system by which a user can appropriately exercise without trainer's help are provided. The exercise management method of a mobile communication terminal in the exercise management system includes receiving an exercise program configured based on user information regarding a user from a trainer console which configures the exercise program, transmitting exercise data included in the exercise program to a health machine, receiving state information indicating a current health state of the user using the health machine from a state sensor when the health machine operates according to the exercise data, determining whether an abnormality occurs in a health state of the user based on the state information, and informing the user of occurrence of the abnormality when the abnormality occurs in the user's health state.

### PRIORITY

This application claims priority under 35 U.S.C. §119(a) to a Korean Patent Application filed in the Korean Intellectual Property Office on Mar. 21, 2012 and assigned Serial No. 10-2012-0028581, the entire disclosure of which is incorporated herein by reference.

### BACKGROUND OF THE INVENTION

1. Field of the Invention

The present invention generally relates to an apparatus and method for managing exercise of a user in a fitness center, and more particularly, to an exercise management apparatus, system, and method by which a user can perform appropriate exercise without a trainer's help.

2. Description of the Related Art

Modern health and fitness machines in fitness centers are automated, such that some tread-mills or health cycles have dedicated software or Android-based solutions mounted thereon. The solutions mounted on the health machines operate only in those health machines, and allow a user to exercise according to a user-set exercise program only when the user manually sets the exercise program.

For conventional health machines, users have to directly set exercise programs, and to this end, the health machines include user input units, such as buttons, for setting the exercise programs and screens capable of displaying the user-set exercise programs. However, those health machines are independent objects and a user needs to directly set an exercise program each time when using each health machine.

When a user exercises using a health machine, generally, the user may use two exercise schemes: one scheme in which the user is supported with coaching from a personal trainer and the other scheme in which the user is supported with coaching from a general trainer.

A personal trainer creates a detailed exercise program customized for the user and continuously helps the user in exercising by the user's side, which can be a very expensive service. A general trainer may be less expensive for the user, but it may be difficult to support the user with separate and detailed coaching. Therefore, the only way for the user to exercise with the support of separate exercise coaching in a fitness center is with a personal trainer.

When users perform exercise by themselves without support or coaching, they may exercise in an incorrect way or incorrectly determine that an exercise is causing an abnormal reaction in the body. Moreover, setting for each health machine is up to users, which may cause user injuries due to mistakes or inappropriate settings.

### SUMMARY OF THE INVENTION

Accordingly, the present invention has been made to solve the above-stated problems occurring in the prior art, and the present invention provides an exercise management apparatus, system, and method by which a user can appropriately exercise without a trainer's help.

According to an aspect of the present invention, there is provided an exercise management method of a mobile communication terminal in an exercise management system, the exercise management method including receiving an exercise program configured based on user information regarding a user from a trainer console which configures the exercise program; transmitting exercise data included in the exercise program to a health machine; receiving state information indicating a current health state of the user using the health machine from a state sensor when the health machine operates according to the exercise data; determining whether an abnormality occurs in a health state of the user based on the state information; and informing the user of occurrence of the abnormality when the abnormality occurs in the user's health state.

According to another aspect of the present invention, there is provided a mobile communication terminal in an exercise management system, the mobile communication terminal including a communication interface configured to receive an exercise program configured based on user information regarding a user using a health machine from a trainer console which configures the exercise program, and transmit exercise data included in the received exercise program to the health machine; and a controller configured to control the communication interface to receive state information indicating a current state of the user from a state sensor which detects a current health state of the user, when the health machine operates according to the exercise data, and determine whether an abnormality occurs in a health state of the user based on the state information.

According to yet another aspect of the present invention, there is provided a health machine in an exercise management system, the health machine including a communication interface configured to receive exercise data, from a mobile communication terminal, including control data for operating an exercise machine; an exercise volume calculator configured to calculate a predicted exercise volume of a user exercising using the exercise machine, when the exercise machine operates according to the exercise data; and a controller configured to operate the exercise machine according to the exercise data, compare an accumulated exercise volume calculated by the exercise volume calculator with a total exercise volume included in the exercise data, and determine whether an abnormality occurs in a health state of the user, based on the comparison result.

According to still another aspect of the present invention, there is provided a trainer console in an exercise management system, the trainer console including a communication interface configured to receive user information regarding a user from a mobile communication terminal; and a controller configured to configure an exercise program for the user based on the user information, and control the communication interface to transmit the exercise program to the mobile communication terminal.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating an exercise management system, according to an embodiment of the present invention;

FIG. 2 is a block diagram illustrating a state sensor and a mobile communication terminal of an exercise management system illustrated in FIG. 1, according to an embodiment of the present invention;

FIG. 3 is a block diagram illustrating a health machine of an exercise management system illustrated in FIG. 1, according to an embodiment of the present invention;

FIG. 4 is a block diagram illustrating a trainer console of an exercise management system illustrated in FIG. 1, according to an embodiment of the present invention;

FIG. 5 is a flowchart illustrating an exercise management method in an exercise management system illustrated in FIG. 1 according to an embodiment of the present invention;

FIG. 6 is a flowchart illustrating an exercise management method in an exercise management system illustrated in FIG. 1 according to an embodiment of the present invention;

FIG. 7 is a flowchart illustrating an exercise management method in a mobile communication terminal of an exercise management system illustrated in FIG. 1 according to an embodiment of the present invention; and

FIG. 8 is a flowchart illustrating an exercise management method in an exercise management system illustrated in FIG. 1 according to an embodiment of the present invention.

### DETAILED DESCRIPTION OF THE EMBODIMENTS OF THE PRESENT INVENTION

Hereinafter, various embodiments of the present invention are described in detail with reference to the accompanying drawings. Throughout the drawings, the same or like drawing reference numerals refer to the same or like elements, features and structures. Additionally, descriptions of well-known functions and constructions are omitted to avoid obscuring the subject matter of the present invention. In the following description, specific examples of configurations and components are merely provided to assist the overall understanding of the embodiments of the present invention and it will be apparent to those skilled in the art that the present invention is not limited to these examples.

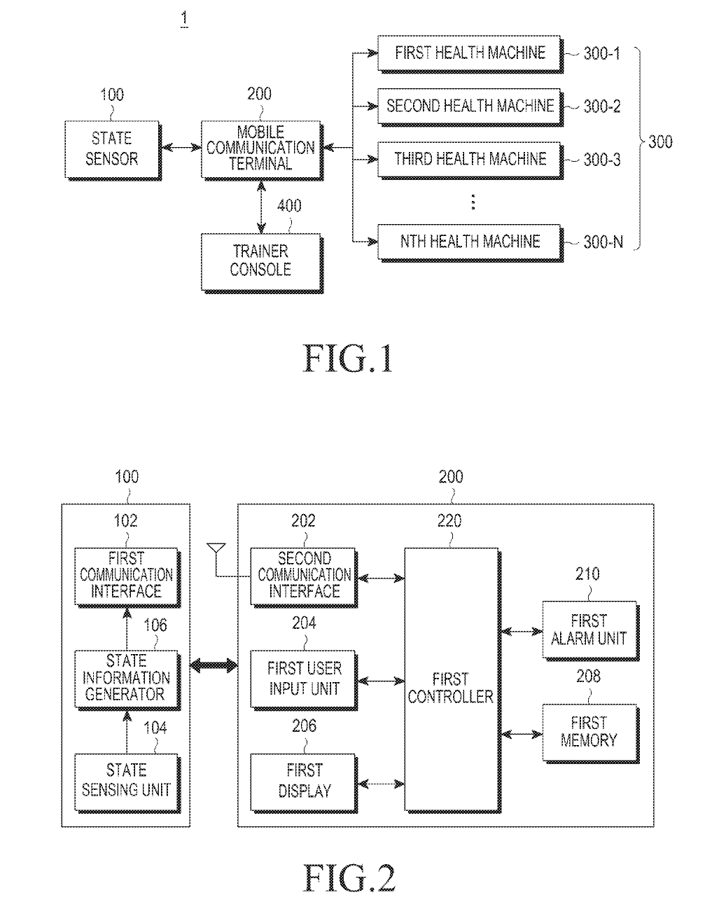

FIG. 1 is a block diagram illustrating an exercise management system 1 according to an embodiment of the present invention.

Referring to FIG. 1, the exercise management system 1 includes a state sensor 100, a mobile communication terminal 200, a health machine 300, and a trainer console 400.

The state sensor 100 is attached to the body of a user who exercises using the health machine 300 to detect a current state of the user, for example, related to the user's health state. According to an embodiment of the present invention, the state sensor 100 includes, for example, an Electrocardiogram (ECG) sensor or a sphygmomanometer. The state sensor 100 detects the user's state every preset time-period, generates state information regarding the detected state, and transmits the generated state information to the mobile communication terminal 200. According to an embodiment of the present invention, the state sensor 100 transmits the state information to the health machine 300 or the trainer console 400.

The mobile communication terminal 200 receives the state information from the state sensor 100 and determines whether an abnormality occurs in a user's current health state. When no abnormality occurs in the health state of the user, the mobile communication terminal 200 informs the user that the user is allowed to continue the exercise. Otherwise, when an abnormality occurs, the mobile communication terminal 200 informs the user that the user needs to stop exercise due to occurrence of the abnormality in the user. According to an embodiment of the present invention, the mobile communication terminal 200 informs user's abnormal state and exercise stop by directly contacting the trainer console 400 or the user's trainer.

The health machine 300 refers to an apparatus which includes at least one exercise machine to allow the user to exercise. Generally, the health machine 300 is provided in a fitness center among a plurality of health machines, for example, a first health machine 300-1, a second health machine 300-2, . . . , an N^{th} health machine 300-N. The health machine 300 receives an exercise program, customized for the user, from the mobile communication terminal 200 and allows the user to operate the machine according to the exercise program. The health machine 300 monitors the user's exercise state to determine whether an abnormality occurs in the user state. When an abnormality occurs, the health machine 300 informs the user or the trainer console 400 that the abnormality occurs in the user state.

The trainer console 400 configures an exercise program which is appropriate for the user, and transmits the appropriate exercise program to the mobile communication terminal 200 of the user. According to an embodiment of the present invention, the trainer console 400 transmits the exercise program to the health machine 300. The exercise program can be configured by user input received from a trainer of the user. The trainer console 400 is notified of detecting an abnormality occurring in the user from the mobile communication terminal 200 or the health machine 300, and informs the trainer of the user of occurrence of the abnormality in the user.

As such, the exercise management system according to the present invention allows the user to exercise without separate coaching of a trainer, and monitors a health state of the user on a real time basis. By monitoring the user's health state in real time, a dangerous health abnormality occurring in the user can be detected, thereby effectively protecting the health of the user.

FIG. 2 is a block diagram illustrating the state sensor 100 and the mobile communication terminal 200 of the exercise management system 1 illustrated in FIG. 1, according to an embodiment of the present invention.

Referring to FIG. 2, the state sensor 100 includes a first communication interface 102, a state sensing unit 104, and a state information generator 106.

The first communication interface 102 performs wired or wireless communication of the state sensor 100. The first communication interface 102 according to an embodiment of the present invention, transmits state information generated by the state information generator 106 to the mobile communication terminal 200.

The first communication interface 102 according to an embodiment of the present invention, performs communication of the state sensor 100 by using a wireless communication scheme, for example, Bluetooth®, Zigbee, a Universal Serial Bus (USB), Wi-Fi, or Antenna (ANT).

The state sensing unit 104 detects the current state of the user exercising, for example, an electrocardiogram (ECG) and a blood pressure. The state sensing unit 104 includes, for example, an ECG sensor and a sphygmomanometer to detect the user's current state. The state sensing unit 104 may measure the user's current state, for example, an ECG and a blood pressure, every previously stored time-period, and forward a corresponding state value to the state information generator 106. For example, the state sensing unit 104 may measure a blood pressure of the user every 10 seconds and forward the measured blood pressure value to the state information generator 106.

The state information generator 106 generates state information indicating the user's current state. The state information generator 106 receives a state value indicating the user's current state, for example, an ECG and a blood pressure, from the state sensing unit 104 to generate state information. The state value is forwarded to the state information generator 106 from the state sensing unit 104 every previously stored time-period.

Referring to FIG. 2, the mobile communication terminal 200 includes a second communication interface 202, a first user input unit 204, a first display 206, a first memory 208, a first alarm unit 210, and a first controller 220.

The second communication interface 202 performs wired or wireless communication of the mobile communication terminal 200. The second communication interface 202 according to an embodiment of the present invention, transmits user information previously stored in the first memory 208 to the trainer console 400, and receives an exercise program from the trainer console 400. The second communication interface 202 transmits the exercise program received from the trainer console 400 to the health machine 300, such that the health machine 300 is set to correspond to the exercise program. The second communication interface 202 receives state information from the state sensor 100 and forwards the received state information to the first controller 220.

The second communication interface 202, according to an embodiment of the present invention performs communication of the mobile communication terminal 200 by using a wireless communication scheme such as Bluetooth®, Zigbee, a USB, WiFi, or ANT.

The first user input unit 204 receives a user input inputted from the user. The first user input unit 204 according to an embodiment of the present invention, receives a user input for executing an exercise program. The first user input unit 204 receives, from the user, for example, a user input for requesting an exercise program from the trainer console 400 and a user input for transmitting exercise data to the health machine 300.

The first display 206 displays data of the mobile communication terminal 200. The first display 206 according to an embodiment of the present invention, displays the exercise program received from the trainer console 400. The first display 206 may also display an exercise stop request for requesting the user to stop exercising, under control of the first controller 220.

The first memory 208 stores various data for controlling the operation of the mobile communication terminal 200. The first memory 208 stores user information regarding a user. The user information includes, for example, body information of the user, such as a name, an age, a gender, a height, and a weight of the user, and a user's exercise history. The user's exercise history includes, for example, daily exercise duration of the user, calories burned by exercise, and a name of a health machine used for exercise. The user information may also include medical information related to user's health (for example, a user's clinical history), wellness, diet information, and so forth.

The first alarm unit 210 informs the user of detecting an abnormality occurring in the user. The first alarm unit 210 informs the user of detecting an abnormality occurring in the user through the first display 206. The first alarm unit 210 may also inform the user of detecting an abnormality occurring in the user by outputting an alarm sound through a speaker provided in the mobile communication terminal 200.

The first controller 220 controls the operation of the mobile communication terminal 200. The first controller 220 according to an embodiment of the present invention, receives an exercise program from the trainer console 400 through the second communication interface 202 and transmits the received exercise program to the health machine 300. The first controller 220 transmits only exercise data corresponding to the health machine 300 out of the exercise program. For example, it is assumed that the exercise program includes exercise data regarding the first health machine 300-1 and exercise data regarding the second health machine 300-2. When the user desires to exercise by using the first health machine 300-1, then the first controller 220 transmits only exercise data regarding the first health machine 300-1 out of the exercise program to the first health machine 300-1.

The exercise data includes, for example, exercise duration data indicating an exercise duration for which the user needs to exercise by using the health machine 300, exercise intensity data indicating the intensity of exercise, and control data for operating the health machine 300. Depending on an embodiment of the present invention, the exercise data may include a total exercise volume assigned to a user. For example, an exercise volume may be calculated in kilo calorie (Kcal) units based on the exercise time data or the exercise intensity data. The total exercise volume may be total kilo calories burned by the user during an exercise using the health machine 300.

When an exercise machine of the health machine 300 starts operating, the first controller 220 receives state information from the state sensor 100 through the second communication interface 202. The first controller 220 may also receive exercise volume data from the health machine 300 through the second communication interface 202.

The first controller 220 analyzes the state information received from the state sensor 100 to determine whether an abnormal health state occurs in the user. For example, it is assumed that the state sensor 100 is an ECG sensor which measures an ECG. It is also assumed that ECG data which is output by the ECG sensor is classified into levels 1 through 10, and levels higher than 8 indicate that an abnormality is occurring in the user's health state. The first controller 220 determines whether ECG data has a level higher than 8 each time when state information including the ECG data is transmitted from the state sensor 100. For the levels higher than 8, the first controller 220 determines that an abnormality occurs in the user state; for the levels lower than 8, the first controller 220 determines that no abnormality occurs in the user state.

When no abnormality occurs in the user state, the first controller 220 determines whether the user has completed the exercise volume (an expected volume) assigned in response to the corresponding health machine 300 according to the exercise program. In the current embodiment, an exercise volume accumulated from start of the user's exercise to the current point in time is referred to as an accumulated exercise volume. An exercise volume of a user's exercise using each health machine 300 is referred to as a predicted exercise volume. The exercise data may further include a predicted exercise volume assigned in response to each health machine 300, and may be calculated based on the exercise time data or the exercise intensity data.

Like the total exercise volume, the accumulated exercise volume and the predicted exercise volume may be calculated in kilo calorie units. For example, it is assumed that a total exercise volume is 500 Kcal, a user's accumulated exercise volume before use of a health machine A is 450 Kcal, and a predicted exercise volume corresponding to the health machine A is 70 Kcal. When the user exercises using the health machine A, the user's accumulated exercise volume is 520 Kcal, exceeding the total exercise volume. In this case, the first controller 220 may determine that abnormality occurs in the user state. Depending on an embodiment of the present invention, the first controller 220 may calculate an accumulated exercise volume when the health machine A is used before the user uses the health machine A. Since the accumulated exercise volume is 520 Kcal when the health machine A is used, the first controller 220 may control the mobile communication terminal 200 to request the user not to use the health machine A.

When the user has not yet met the predicted exercise volume, the first controller 220 controls the mobile communication terminal 200 to urge the user to continuously exercise. The first controller 220 displays an alarm window through the first display 206 to urge the user to continue exercising.

Conversely, when the user completes the predicted exercise volume, the first controller 220 controls the mobile communication terminal 200 to urge the user to stop exercising on the health machine 300. For example, it is assumed that a predicted exercise volume which is set for the first health machine 300-1 of the user is ‘an exercise duration of 30 minutes’. When the user completed the predicted exercise volume assigned to the first health machine 300-1, that is, when the user exercises by using the first health machine 300-1 for 30 minutes, the first controller 220 may request the user to stop exercising which uses the first health machine 300-1. When there is exercise data corresponding to other health machines 300-2 through 300-N in the exercise program after the exercise using the first health machine 300-1, the first controller 220 may guide the user to the corresponding health machines 300-2 through 300-N.

When an abnormality occurs in the user state, the first controller 220 may request the user to stop exercising while informing the user of occurrence of the abnormality in the user. The first controller 220 displays an exercise stop message or output an alarm sound to request the user to stop exercising through the first alarm unit 212. The first controller 220 may also generate an operation stop request message for requesting stop of an operation of the exercise machine. The first controller 220 may stop the operation of the exercise machine by transmitting the operation stop request message to the health machine 300 through the second communication interface 202.

According to an embodiment of the present invention, the first controller 220 of the mobile communication terminal 200 includes an application stored in the first memory 208. For example, the first controller 220 may be implemented as a fitness application, such that upon input of a user input for executing the fitness application, the fitness application may be executed in the mobile communication terminal 200.

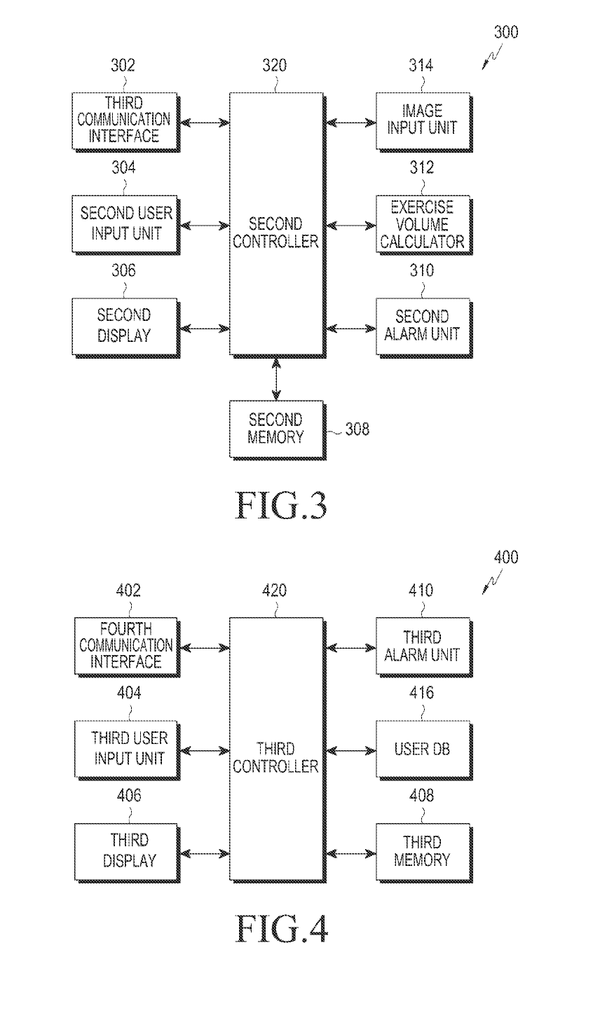

FIG. 3 is a block diagram illustrating the health machine 300 in the exercise management system 1 illustrated in FIG. 1.

Referring to FIG. 3, the health machine 300 includes a third communication interface 302, a second user input unit 304, a second display 306, a second memory 308, a second alarm unit 310, an exercise volume calculator 312, an image input unit 314, and a second controller 320.

The third communication interface 302 performs wired or wireless communication of the health machine 300. The third communication interface 302, according to an embodiment of the present invention, receives exercise data for operating an exercise machine from the mobile communication terminal 200. The third communication interface 302 transmits exercise volume data calculated from the exercise volume calculator 312 to the mobile communication terminal 200 or the trainer console 400.

The third communication interface 302 performs communication of the health machine 300 by using a wireless communication scheme, for example, Bluetooth®, Zigbee, a USB, WiFi, or ANT connections.

The second user input unit 304 receives a user input inputted from the user. The second user input unit 304 according to an embodiment of the present invention, receives a user input for operating an exercise machine. The second user input unit 304 receives a user input for stopping the operation of the exercise machine.

The second display 306 displays data of the health machine 300. The second display 306 according to an embodiment of the present invention, displays user's exercise duration and exercise intensity based on the exercise data received from the mobile communication terminal 300. The second display 306 displays a user's exercise volume calculated by the exercise volume calculator 312 under control of the second controller 320. The second display 306 displays an exercise stop request for requesting the user to stop exercising, under control of the second controller 320.

The second memory 308 stores various data for controlling the operation of the health machine 300. The second memory 308 according to an embodiment of the present invention, stores the exercise data received from the mobile communication terminal 200 or stores user information regarding a user who exercises using the health machine 300.

The second alarm unit 310 informs the user of detecting an abnormality occurring in the user. The second alarm unit 310 informs the user of detecting an abnormality occurring in the user state through the second display 306. The second alarm unit 310 may also inform the user of detecting an abnormality occurring in the user and request the user to stop exercising by outputting an alarm sound through a speaker previously provided in the health machine 300.

The exercise volume calculator 312 calculates a exercise volume of the user who exercises using the exercise machine. The exercise volume calculated by the exercise volume calculator 312 includes, for example, calories burned by the exercise or duration of exercise. According to an embodiment of the present invention, the exercise volume calculator 312 may calculate calories burned by the user in real time or in every predetermined time-period. The calculated calories are displayed through the second display 306.

The image input unit 314 includes at least one camera to capture an image of the user during exercise using the exercise machine. The image input unit 314 according to an embodiment of the present invention, forwards the image of the user captured every previously stored time-period to the second controller 320. The image captured by the image input unit 314 may be displayed through the second display 306.

The second controller 320 controls the operation of the health machine 300. The second controller 320 according to an embodiment of the present invention, receives the exercise data from the mobile communication terminal 200 through the third communication interface 302. The second controller 320 analyzes the exercise data to operate the exercise machine. The second controller 320 analyzes the exercise data, for example to determine user's exercise duration, exercise intensity, and total calories burned during exercise, and operates the exercise machine.

When the exercise machine starts operating, the second controller 320 controls the exercise volume calculator 312 to calculate user's exercise volume in real time. The second controller 320 determines whether the exercise volume progress calculated by the exercise volume calculator 312 meets the exercise volume included in the exercise data. For example, the second controller 320 may stop the operation of the exercise machine when the calories calculated by the exercise volume calculator 312 are greater than or equal to those included the exercise data. Thus, the health machine 300 according to the present invention may prevent a situation where an abnormality occurs in the user state because the user exercises more than necessary.

When the calories burned by the user's exercise are greater than the exercise volume included in the exercise data, the second controller 320 determines that an abnormality occurs in the user state. The second controller 320 may also inform the user that an abnormality occurs in the user state through the second alarm unit 310.

The second controller 320 determines whether a user's exercise form and posture is correct from the image captured by the image input unit 314. When the user's exercise form and posture is not correct, the second controller 320 displays a correct form through the second display 306. The second memory 320 may previously store exercise form data regarding a correct exercise form when the user exercises, and the second controller 320 determines based on the exercise form data previously stored in the second memory 308 whether the user's exercise form is correct.

When the user completes the exercise, the second controller 320 generates exercise result data indicating a result of the exercise the user completes, and transmits the exercise result data to the mobile communication terminal 200 through the third communication interface 302. The exercise result data includes, for example, a name of the corresponding health machine 300, total calories burned by user's exercise completion, exercise intensity, exercise duration and other exercise volume data.

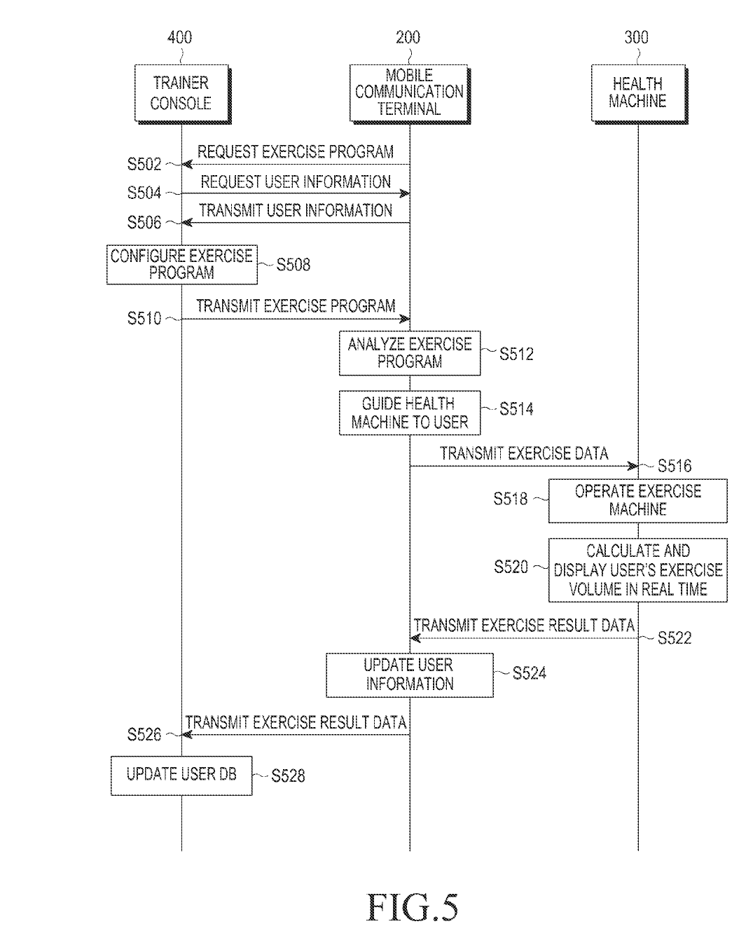

FIG. 4 is a block diagram illustrating the trainer console 400 in the exercise management system 1 illustrated in FIG. 1, according to an embodiment of the present invention.

Referring to FIG. 4, the trainer console 400 includes a fourth communication interface 402, a third user input unit 404, a third display 406, a third memory 408, a third alarm unit 410, a user database (DB) 416, and a third controller 420.

The fourth communication interface 402 performs wired or wireless communication of the trainer console 400. The fourth communication interface 402 according to an embodiment of the present invention, receives a request for an exercise program from the mobile communication terminal 200. The fourth communication interface 402 requests and receives user information from the mobile communication terminal 200. The fourth communication interface 402 transmits the exercise program configured by the third controller 420 to the mobile communication terminal 200.

The third user input unit 404 receives a user input for configuring the exercise program from a trainer. The third user input unit 404 may also directly receive user information from the user using the mobile communication terminal 200.

The third display 406 displays various data stored in the trainer console 400. The third display 406 according to an embodiment of the present invention, displays an alarm window for informing the trainer of detecting an abnormality occurring in the user, under control of the third controller 420.

The third memory 408 stores various data for controlling the operation of the trainer console 400.

The third alarm unit 410 informs the trainer of detecting an abnormality occurring in the user. The third alarm unit 410 displays detecting an abnormality occurring in the user through the third display 406 to inform the trainer of detecting an abnormality occurring in the user. The third alarm unit 410 may also output an alarm sound through a speaker previously provided in the trainer console 400 to inform the trainer of detecting an abnormality occurring in the user, such that the trainer may be requested to immediately handle the abnormality occurring in the user. The third alarm unit 410 informs the trainer of occurrence of the abnormality in the user by calling the trainer.

The user DB 416 stores user information corresponding to respective users who use a fitness center. The user DB 416 may also store information about a trainer corresponding to each user. The user information stored in the user DB 416 may be updated each time when the user exercises. Hence, the trainer console 400 may recognize a user's exercise history, thereby systemically coaching the user for exercise.

The third controller 420 controls the overall operation of the trainer console 400. The trainer console 400 according to an embodiment of the present invention, configures an exercise program corresponding to each user. When the fourth communication interface 402 receives a request for an exercise program from the mobile communication terminal 200, then the third controller 420 configures the exercise program based on the user information stored in the user DB 416. According to an embodiment of the present invention, the third controller 420 may send a request for user information to the mobile communication terminal 200 through the fourth communication interface 402. When the exercise program is configured, the third controller 420 transmits the exercise program to the mobile communication terminal 200 through the fourth communication interface 402.

When the user terminates the exercise using the health machine 300, the third controller 420 receives exercise result data from the health machine 300 through the fourth communication interface 402. The third controller 420 may update the user information stored in the user DB 416 based on the exercise result data.

The third controller 420 may be notified of detecting an abnormality occurring in the user from the mobile communication terminal 200 or the health machine 300 through the fourth communication interface 402. The third controller 420 may request the health machine 300 to immediately stop the operation of the exercise machine through the fourth communication interface 402, and may urgently call the trainer corresponding to the user through the third alarm unit 410.

FIG. 5 is a flowchart illustrating an exercise management method in the exercise management method illustrated in FIG. 1 according to an embodiment of the present invention.

In FIG. 5, it is assumed that no user health state abnormality occurs when the user exercises using an exercise machine. Referring to FIG. 5, the mobile communication terminal 200 sends a request for an exercise program to the trainer console 400 in Step S502. Upon receiving the request for the exercise program, the trainer console 400 sends a request for user information to the mobile communication terminal 200 in Step S504. The mobile communication terminal 200 transmits the user information to the trainer console 400 in Step S506. The third controller 420 of the trainer console 400 configures the exercise program based on the user information in Step S508.

While the trainer console 400 sends the request for the user information to the mobile communication terminal 200 in FIG. 5, the trainer console 400 configures the exercise program by using user information previously stored in the user DB 416 without sending the request for the user information to the mobile communication terminal 200 according to an embodiment of the present invention.

After the exercise program is configured, the fourth communication interface 402 of the trainer console 400 transmits the exercise program configured in Step S508 to the mobile communication terminal 200 in Step S510.

When the mobile communication terminal 200 receives the exercise program from the trainer console 400, the second controller 220 of the mobile communication terminal 200 analyzes the exercise program in Step S512. The exercise program includes, for example, a name of the health machine 300 to be used for exercise, a use order of the health machine 300, and exercise data corresponding to the health machine 300. The second controller 220 may recognize the use order of the health machine 300 to be used by the user and the user's exercise volume by analyzing the exercise program. As such, when the exercise program is analyzed, the mobile communication terminal 200 guides the health machine 300 the user needs to use for exercise to the user according to the exercise program in Step S514.

The mobile communication terminal 200 transmits exercise data to the health machine 300 in Step S516. The exercise data includes control data for operating the health machine 300, such that the heath machine 300 operates an exercise machine based on the exercise data in Step S518. When the exercise machine operates, the health machine 300, on a real time basis, calculates and displays a exercise volume of the user exercising using the exercise machine in Step S520. When the user completes the exercise, the second controller 320 of the health machine 300 generates exercise result data for the user and transmits the generated exercise result data to the mobile communication terminal 200 in Step S522. The exercise result data includes, for example, a name of the corresponding health machine 300, total calories burned by user's exercise, exercise intensity, and exercise duration.

In Step S524, the mobile communication terminal 200 updates the user information based on the exercise result data received in Step S522. The mobile communication terminal 200 transmits the exercise result data to the trainer console 400 in Step S526. The trainer console 400 updates the user DB 308 based on the exercise result data in Step S528.

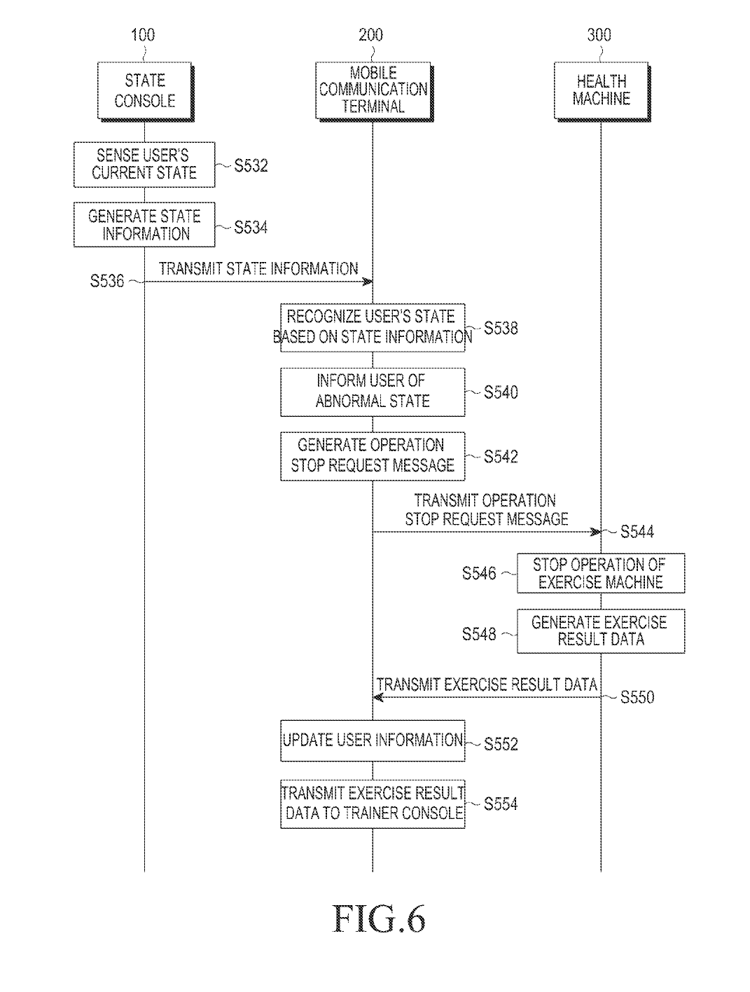

FIG. 6 is a flowchart illustrating an exercise management method in the exercise management method illustrated in FIG. 1 according to an embodiment of the present invention. In FIG. 6, it is assumed that an abnormality occurs in the user state during user's exercise.

Referring to FIG. 6, the state sensor 100 detects a current state of the user exercising using an exercise machine in Step S532 and generates state information in Step S534. According to an embodiment of the present invention, the state sensor 100 detects the user's current state for every previously stored time period and generates state information.

The state sensor 100 transmits the state information generated in Step S534 to the mobile communication terminal 200 in Step S536. The first controller 220 of the mobile communication terminal 200 recognizes the user's state based on the state information in Step S538. When an abnormality occurs in the user state, the second controller 220 informs the user of occurrence of the abnormality, that is, of an abnormal state through the first alarm unit 208 in Step S504. The first alarm unit 208 may output an alarm sound or display an alert message through the first display 206 to inform the user of detecting an abnormality occurring in the user's health state.

The second controller 220 generates an operation stop request message for requesting stop of an operation of the exercise machine in Step S542, and transmits the generated operation stop request message to the health machine 300 through the second communication interface 202 in Step S544. Upon detecting an abnormality occurring in the user, it is desirable to stop the operation of the exercise machine even when user's exercise duration assigned to the user by the exercise program is not terminated. Therefore, the second controller 220 of the mobile communication terminal 200 may protect the user by requesting the health machine 300 to stop the operation of the exercise machine.

The health machine 300, upon receiving the operation stop request message from the mobile communication terminal 200 in Step S544, stops the operation of the exercise machine in Step S546. When the user's exercise is terminated, the health machine 300 generates user's exercise result data in Step S548 and transmits the exercise result data to the mobile communication terminal 200 in Step S550. The exercise result data includes, for example, user's actual exercise duration and burned calories.

The mobile communication terminal 200, upon receiving the exercise result data from the health machine 300, updates the user information stored in the first memory 208 in Step S522. According to an embodiment of the present invention, the mobile communication terminal 200 transmits the exercise result data received in Step S550 to the trainer console 400 in Step S554. The trainer console 400 receives the exercise result data and updates the user DB 408.

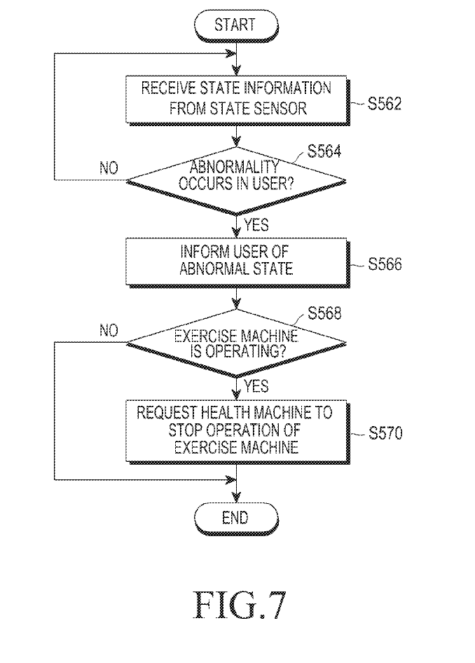

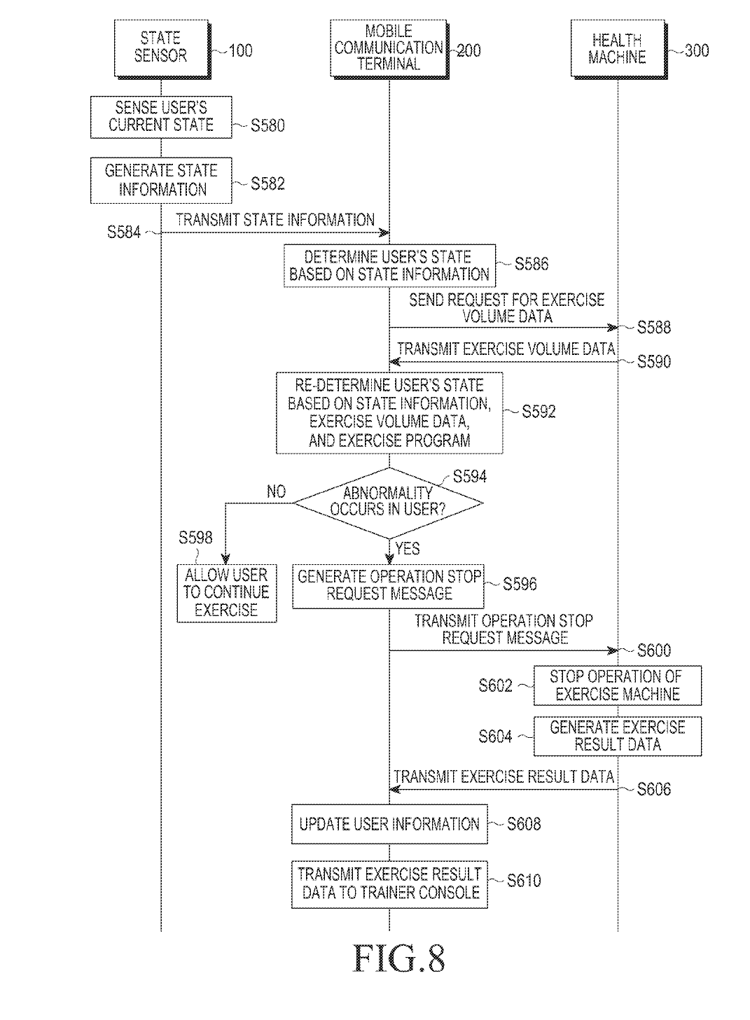

FIG. 7 is a flowchart illustrating an exercise management method in the mobile communication terminal 200 of the exercise management system illustrated in FIG. 1, according to an embodiment of the present invention. In FIG. 8, it is assumed that the user is exercising according to the exercise program configured by the trainer console 400.

Referring to FIG. 7, the mobile communication terminal 200 receives state information regarding the user from the state sensor 100 in Step S562. According to an embodiment of the present invention, the mobile communication terminal 200 receives the state information from the state sensor 100 every previously stored time-period. The state information may be, for example, user's ECG and blood pressure.

In Step S564, the first controller 220 determines whether an abnormality occurs in the user state based on the state information received in Step S562. For example, it is assumed that when the user's systolic blood pressure is 130 mmHg or higher, the first controller 220 determines that an abnormality occurs in the user state. In Step S564, the first controller 220 determines whether the user's blood pressure is 130 mmHg or higher and for 140 mmHg or higher, the first controller 220 determines that an abnormality occurs in the user state.

If determining that no user state abnormality occurs in Step S564 (‘No’ in Step S564), the first controller 220 continuously receives the state information through the second communication interface 202. According to an embodiment of the present invention, the first controller 220 informs the user that the user is allow to continue exercise, through the first display 206.

Conversely, when determining that a user state abnormality occurs in Step S564 (‘Yes’ in Step S564), the first controller 220 controls the first alarm unit 210 to inform the user of an abnormal state of the user in Step S566. The first alarm unit 210 may output an alarm sound through a speaker previously provided in the mobile communication terminal 200 or display an alert message through the first display 206 to inform the user of the user's abnormal state.

The first controller 220 determines whether the exercise machine of the health machine 300 is operating in Step S568. The first controller 220 determines whether the exercise machine is being operation based on the exercise data included in the exercise program. For example, it is assumed that the user is exercising using the second health machine 300-2 according to the exercise program. The first controller 220 may recognize exercise duration for which the user is supposed to exercise using the second health machine 300-2, based on exercise data included in the exercise program, that is, exercise data corresponding to the second health machine 300-2. The first controller 220 calculates, based on the exercise data corresponding to the second health machine 300-2, an elapsed time-period, from a time instant at which the exercise machine starts operating to a current time instant. When the calculated elapsed time-period is shorter than the exercise duration included in the exercise data, then the exercise machine is determined as operating; when the elapsed time is longer than or equal to the exercise duration included in the exercise data, then the exercise machine is determined to have already terminated its operation. The time instant at which the exercise machine starts operating may be, for example, a time instant at which transmission of the exercise data from the mobile communication terminal 200 to the health machine 300-2 starts under control of the first controller 220.

When the exercise machine is operating (‘Yes’ in Step S568), the first controller 220 requests the health machine 300 to stop the operation of the exercise machine in Step S570. Since an abnormality occurs in the user state, it is desirable to stop the operation of the exercise machine to prevent the user from excessively exercising. Conversely, when the exercise machine is not being operated (‘No’ in Step S568), the first controller 220 may not perform any special operation.

FIG. 8 is a flowchart illustrating an exercise management method in the exercise management system illustrated in FIG. 1, according to an embodiment of the present invention.

Referring to FIG. 8, the state sensor 100 detects the current state of the user exercising using the exercise machine in Step S580, and generates the state information according to the sensing result in Step S582. According to an embodiment of the present invention, the state sensor 100 detects the user's current state and generates the state information every previously stored time-period.

The state sensor 100 transmits the state information generated in Step S582 to the mobile communication terminal 200 in Step S584. The first controller 220 of the mobile communication terminal 200 determines the user's state based on the state information in Step S586.

According to an embodiment of the present invention, when an abnormality occurs in the user's state determined in Step S586, the first controller 220 uses data of the health machine 300 or the trainer console 400, that is, exercise data and the exercise program, as a basis for determining the user's state, together with the state information. That is, the first controller 220 determines whether an abnormality occurs in the user's health, based on the exercise program and the current exercise volume data for the user as well as the state information.

The first controller 220 sends a request for exercise volume data to the health machine 300 through the second communication interface 202 in Step S588. When the health machine 300 transmits the exercise volume data to the mobile communication terminal 200 in Step S590, the first controller 220 re-determines the user's state based on the state information, the exercise volume data, and the exercise program in Step S592.

The first controller 220 determines whether an abnormality occurs in the user state in Step S594. When no abnormality occurs in the user state (‘No’ in Step S594), the first controller 220 may control the mobile communication terminal 200 to allow the user to continue the exercise in Step S598. According to an embodiment of the present invention, the first controller 220 may generate a message for requesting the user to continue the exercise and display the generated message through the first display 206. The first controller 220 may also request the health machine 300 to display the message for requesting the user to continue the exercise through the second display 306.

Conversely, when an abnormality occurs in the user state (‘Yes’ in Step S594), the first controller 220 generates an operation stop request message for requesting stop of the operation of the exercise machine in Step S596. The generated operation stop request message is transmitted to the health machine 300 through the second communication interface 202 in Step S600. The health machine 300, upon receiving the operation stop request message from the mobile communication terminal 200 in Step S600, stops the operation of the exercise machine in Step S602.

As such, when the user's exercise is terminated, the health machine 300 generates user's exercise result data in Step S604 and transmits the generated exercise result data to the mobile communication terminal 200 in Step S606. The exercise result data includes, for example, user's actual exercise duration and burned calories.

The mobile communication terminal 200 having received the exercise result data from the health machine 300 updates the user information stored in the first memory 208 in Step S608. According to an embodiment of the present invention, the mobile communication terminal 200 transmits the exercise result data received in Step S606 to the trainer console 400 in Step S610.

The embodiments of the present invention can be implemented with hardware, software, or a combination of hardware and software. The software may be stored in a volatile or non-volatile storage such as a Read-Only Memory (ROM), a memory such as a Random Access Memory (RAM), a memory chip, a device, or an integrated circuit, and an optically or magnetically recordable and machine (e.g., computer)-readable storage medium such as a Compact Disc (CD), a Digital Versatile Disk (DVD), a magnetic disk, or a magnetic tape. A memory which can be included in a host includes, for example, a machine-readable storage medium which is suitable for storing a program or programs including instructions for implementing the methods according to the embodiments of the present invention. Therefore, the present invention includes a program including codes for implementing a device or method according to embodiments of the present invention and a machine-readable storage medium for storing such a program. The program may be electronically transferred through a medium such as a communication signal delivered through wired or wireless connection.

The mobile communication terminal, the trainer console, or the health machine according to embodiments of the present invention receives and stores the program from a program providing device connected in a wired or wireless manner. The program providing device includes a memory for storing a program including instructions for instructing the mobile communication terminal, the trainer console, or the health machine to execute a preset exercise management method, including information necessary for the exercise management method, a communication unit for performing wired or wireless communication with the mobile communication terminal, the trainer console, or the health machine, and a controller for transmitting a corresponding program to the mobile communication terminal, the trainer console, or the health machine at the request of the mobile communication terminal, the trainer console, or the health machine or automatically.

While the present invention has been shown and described with reference to various embodiments thereof, it will be understood by those skilled in the art that various changes in form and details may be made without departing from the spirit and scope of the present invention as defined by the appended claims.

What is claimed is:

1. An exercise management method of a mobile communication terminal in an exercise management system, the exercise management method comprising:
receiving an exercise program configured based on user information regarding a user from a trainer console which configures the exercise program;
transmitting exercise data included in the exercise program to a health machine;
receiving state information indicating a current health state of the user using the health machine from a state sensor when the health machine operates according to the exercise data;
determining whether an abnormality occurs in a health state of the user based on the state information; and
informing the user of occurrence of the abnormality when the abnormality occurs in the user's health state.

2. The exercise management method of claim 1, wherein the user information includes at least one of age, gender, height, weight, exercise history, medical information, health information, and diet information of the user.

3. The exercise management method of claim 1, wherein the exercise program includes at least one of names of health machines to be used by the user, a use order of the health machines, and an exercise duration assigned to each of the health machines, and
wherein the exercise data includes at least one of control data for operating each of the health machines, a predicted exercise volume assigned in response to each of the health machines, and a user's total exercise volume.

4. The exercise management method of claim 1, further comprising, before receiving the exercise program, requesting the exercise program by transmitting the user information to the trainer console.

5. The exercise management method of claim 1, further comprising:
receiving exercise result data regarding the exercise from the health machine when the user's exercise is terminated; and
updating the user information based on the exercise result data.

6. The exercise management method of claim 1, further comprising informing the user that the user is allowed to continue the exercise when no abnormality occurs in the user's health state.

7. The exercise management method of claim 1, further comprising determining whether to terminate an operation of the health machine and requesting the health machine to stop operating when the operation of the health machine is determined to terminate.

8. A mobile communication terminal in an exercise management system, the mobile communication terminal comprising:
a communication interface configured to:
receive an exercise program configured based on user information regarding a user using a health machine from a trainer console which configures the exercise program, and
transmit exercise data included in the received exercise program to the health machine; and
a controller configured to:
control the communication interface to receive state information indicating a current state of the user from a state sensor which detects a current health state of the user, when the health machine operates according to the exercise data, and
determine whether an abnormality occurs in a health state of the user based on the state information.

9. The mobile communication terminal of claim 8, wherein the user information includes at least one of age, gender, height, weight, exercise history, medical information, health information, and diet information of the user.

10. The mobile communication terminal of claim 8, wherein the exercise program includes at least one of names of health machines to be used by the user, a use order of the health machines, and an exercise duration assigned to each of the health machines, and
the exercise data includes at least one of control data for operating each of the health machines and a exercise volume assigned in response to each of the health machines.

11. The mobile communication terminal of claim 8, further comprising a memory configured to store the user information,
wherein the controller controls the communication interface to transmit the user information to the trainer console and receive the exercise program configured based on the user information from the trainer console.

12. The mobile communication terminal of claim 8, wherein the controller informs the user of detecting an abnormality occurring in the health of the user when the abnormality occurs in the user's health state.

13. The mobile communication terminal of claim 12, wherein the controller determines whether to terminate an operation of the health machine and controls the communication interface to request the health machine to stop operating when the operation of the health machine is determined to terminate.

14. The mobile communication terminal of claim 8, wherein the controller informs the user that the user is allowed to continue the exercise when no abnormality occurs in the user's health state.

15. The mobile communication terminal of claim 8, wherein the controller determines whether to terminate an operation of the health machine, controls the communication interface to receive exercise result data regarding the exercise from the health machine, and updates the user information based on the received exercise result data.

16. A health machine in an exercise management system, the health machine comprising:
a communication interface configured to receive exercise data, from a mobile communication terminal, comprising control data for operating an exercise machine;
an exercise volume calculator configured to calculate predicted exercise volume of a user exercising using the exercise machine, when the exercise machine operates according to the exercise data; and
a controller configured to:
operate the exercise machine according to the exercise data,
compare an accumulated exercise volume calculated by the exercise volume calculator with a total exercise volume included in the exercise data, and
determine whether an abnormality occurs in a health state of the user, based on the comparison result.

17. The health machine of claim 16, wherein when the abnormality occurs in the user's health state, the controller informs the user of occurrence of the abnormality, and when no abnormality occurs in the user's health state, the controller informs the user that the user is allowed to continue the exercise using the exercise machine.

18. A trainer console in an exercise management system, the trainer console comprising:
a communication interface configured to receive user information regarding a user from a mobile communication terminal; and
a controller configured to:
configure an exercise program for the user based on the user information, and
control the communication interface to transmit the exercise program to the mobile communication terminal.

19. The trainer console of claim 18, wherein,
when the user's exercise according to the exercise program is terminated, the communication interface receives exercise result data regarding the exercise from the mobile communication terminal, and
the controller updates the user information based on the exercise result data.
